(19) United States
(12) Patent Application Publication
(10) Pub. No.: US 2025/0360042 A1
(43) Pub. Date: Nov. 27, 2025

(54) AUTOMATIC MASSAGE APPARATUS

(71) Applicant: SZU WEI SUN, HSINCHU COUNTY (TW)

(72) Inventor: SZU WEI SUN, HSINCHU COUNTY (TW)

(21) Appl. No.: 18/671,227

(22) Filed: May 22, 2024

(51) Int. Cl. A61H 7/00

(52) U.S. Cl. CPC A61H 7/004; A61H 2201/0207; A61H 2201/169

(57) ABSTRACT

An automatic massage apparatus includes a control device; and an auxiliary diagnosis device including a hand, a mechanical arm, and a plurality of pivotal fingers. The auxiliary diagnosis device is electronically connected to the control device which controls the hand, the mechanical arm, and the pivotal fingers. The hand includes a dorsal palm as a top surface and a palm as a bottom. The dorsal palm includes a first socket. The mechanical arm includes a first universal joint at an end. The first universal joint is pivotably disposed in the first socket so that the hand may pivot about the mechanical arm. The hand further includes a plurality of second sockets on a surface. The pivotal fingers each include a second universal joint at an end. The second universal joint is pivotably disposed in the second socket so that the pivotal finger may pivot about the hand.

### FIELD OF THE INVENTION

The invention relates to rehabilitating apparatuses and more particularly to an automatic massage apparatus.

### BACKGROUND OF THE INVENTION

With the development of modern medicine, people pay more attention to rehabilitation after surgery or sports injuries. In the current field of physical therapy, a physical therapist generally listens to a patient's demands, and then use his or her professionalism and experience to make a correct evaluation and judgment prior to treating or rehabilitating the patient.

However, for the physical therapists, when they face a large number of patients for a long period of time and perform rehabilitation exercises over and over again, the physical therapists themselves are prone to occupational injuries due to repetitive movements for a long period of time. Further, the biggest problem is that the physical therapist only has two hands in the treatment process. Many assessments and treatment activities actually require more arms to assist (e.g., the assistance of nurses). Since the training and education of the physical therapists are not easy and it is often that there is no sufficient manpower. It is very likely that it is difficult for both patients and therapists to effectively grasp the golden rehabilitation period in order to carry out sufficient rehabilitation treatments. As a result, it leads to the failure of expected rehabilitation goals.

Thus, the need for improvement still exists.

### SUMMARY OF THE INVENTION

It is therefore one object of the invention to provide an automatic massage apparatus comprising a control device; and an auxiliary diagnosis device including a hand, a mechanical arm, and a plurality of pivotal fingers wherein the auxiliary diagnosis device is electronically connected to the control device which controls the hand, the mechanical arm, and the pivotal fingers, the hand includes a dorsal palm as a top surface and a palm as a bottom, the dorsal palm includes a first socket, the mechanical arm includes a first universal joint at an end, the first universal joint is pivotably disposed in the first socket so that the hand is configured to pivot about the mechanical arm at any angle, the hand further comprises a plurality of second sockets on a surface, the pivotal fingers each include a second universal joint at an end, and the second universal joint is pivotably disposed in the second socket so that the pivotal finger is configured to pivot about the hand at any angle.

The invention has the following advantages and benefits in comparison with the conventional art: the mechanical arm, the pivotal fingers, and the hand cooperate to operate individually and independently in their operations similar to the hand and the fingers of a human being. That is, the body part of the patient is massaged or rehabilitated similar to by means of a human hand. For example, the thumb and the palm press the body part concurrently. As a result, the efficiency of the patient rehabilitated by the physical therapist is greatly increased with the assistance of the invention. Further, it can decrease occupational injuries and solve the problem of manpower shortage.

Above and other objects, features and advantages of the invention will become apparent from the following detailed description taken with the accompanying drawings.

### BRIEF DESCRIPTION OF THE DRAWINGS

FIG. 1 is a perspective view of an auxiliary diagnosis device of an automatic massage apparatus according to a first preferred embodiment of the invention;

FIG. 2 is an exploded view of the auxiliary diagnosis device in FIG. 1;

FIG. 3 is a block diagram of the automatic massage apparatus;

FIG. 4 is a front view of the auxiliary diagnosis device schematically showing the hand divided into upper and lower halves;

FIG. 5 is a front view of the auxiliary diagnosis device schematically showing each of the palm and the pivotal finger provided with a elastic layer and a heating element;

FIG. 6 is an environmental view showing an upper limb of a patient being stabilized by and massaged by the pivotal fingers;

FIG. 7 is an environmental view showing the forearm of the patient being massaged or pressed by the palm;

FIG. 8 is an environmental view showing the forearm of the patient being stabilized by and massaged by the two auxiliary diagnosis devices; and

FIG. 9 is a perspective view of an auxiliary diagnosis device of an automatic massage apparatus according to a second preferred embodiment of the invention.

### DETAILED DESCRIPTION OF THE INVENTION

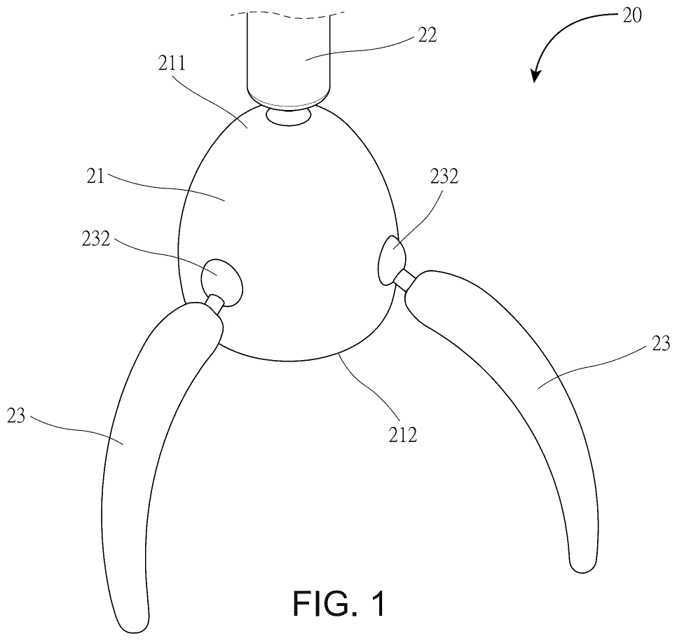

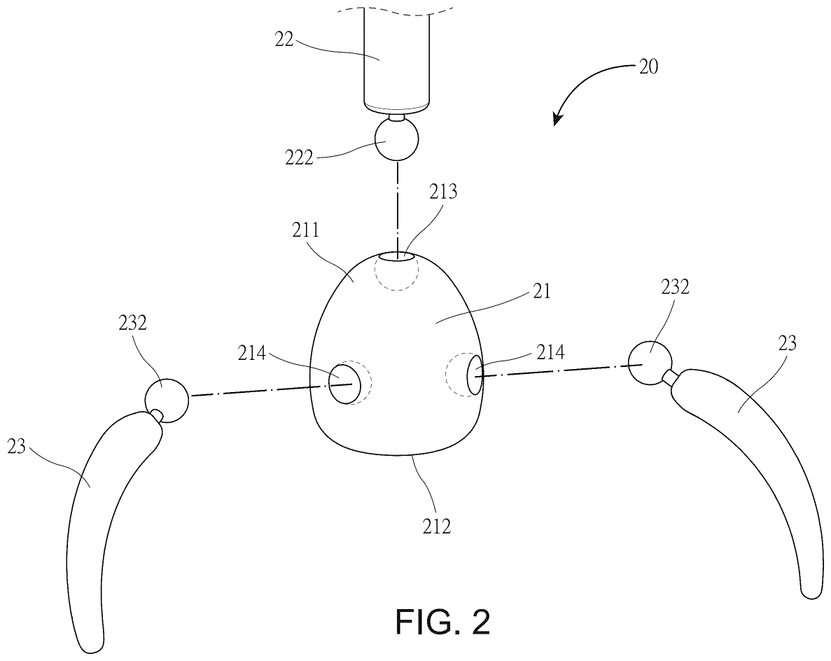

Referring to FIGS. 1 to 8, an automatic massage apparatus 100 in accordance with a first preferred embodiment of the invention comprises a control device 10 and an auxiliary diagnosis device 20 as discussed in detail below.

The auxiliary diagnosis device 20 includes a hand 21, a mechanical arm 22, and a plurality of pivotal fingers 23. In the embodiment, the number of the pivotal fingers 23 is two or three but not limited to such. The auxiliary diagnosis device 20 is electronically connected to the control device 10 which in turn controls the hand 21, the mechanical arm 22, and the pivotal fingers 23. The hand 21 is conic and has a small upper portion and a large lower portion. Further, a bottom of the hand 21 is slightly tapered inward.

Top and bottom of the hand 21 are provided with a dorsal palm 211 and a palm 212 respectively. The dorsal palm 211 includes a first socket 213. The mechanical arm 22 includes a first universal joint 222 at an end. The first universal joint 222 and the first socket 213 are complementary so that the first universal joint 222 may be pivotably disposed in the first socket 213. As a result, the hand 21 may pivot about the mechanical arm 22 at any angle. The hand 21 includes a plurality of second sockets 214 on a surface. The pivotal finger 23 is bent and includes a second universal joint 232 at an end. The second universal joint 232 and the second socket 214 are complementary so that the second universal joint 232 may be pivotably disposed in the second socket 214. As a result, the pivotal finger 23 may pivot about the hand 21 at any angle. However, the hand 21 is not limited to that shown in the figures. Hand 21 may have different shapes and styles to pivot about the mechanical arm 22 through the first universal joint 222.

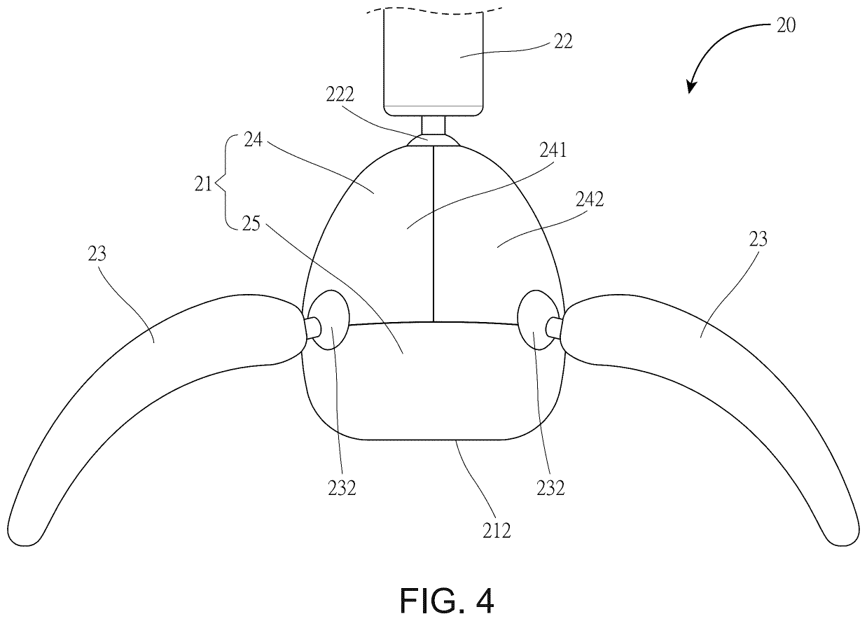

The hand 21 is formed integrally or formed of a number of parts which are assembled. As shown in FIG. 4 specifically, the hand 21 includes two halves, i.e., a first half 24 and a second half 25. The first half 24 and the second half 25 are assembled correspondingly so that each of the second universal joints 232 may be pivotably disposed in each of the second sockets 214. The first half 24 includes a left side 241 and a right side 242. The left side 241 and the right side 242 are assembled correspondingly so that the first universal joint 222 may be pivotably disposed in the first socket 213. It is noted that there are many other assemblies and the embodiment is limited not to that as shown.

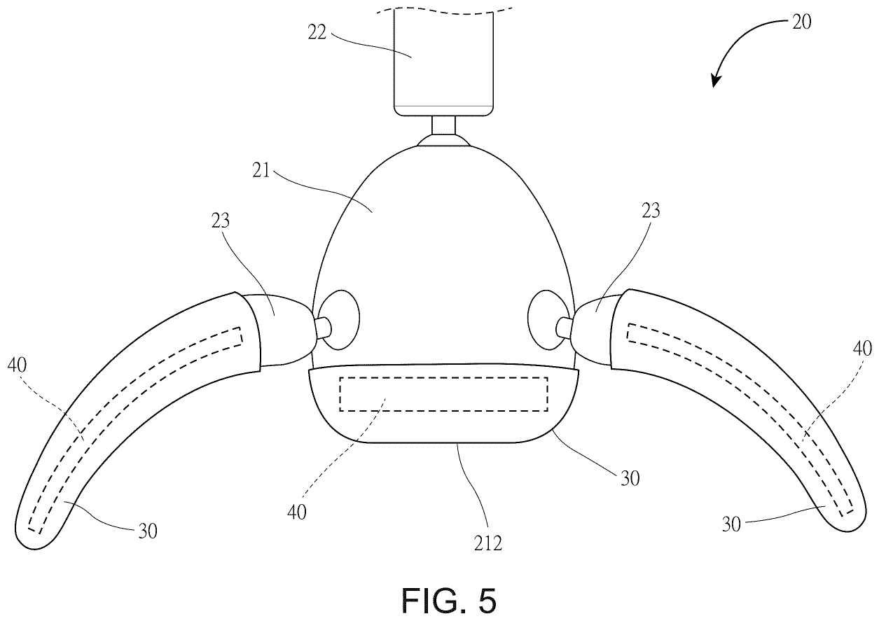

As shown in FIG. 5 specifically, each of the palm 212 of the hand 21 and the pivotal finger 23 is provided with a elastic layer 30 on an outer surface. The elastic layer 30 is formed of silicone or leather. Also, a heating element 40 is provided in the hand 21 and each of the pivotal fingers 23 respectively. The heating element 40 is formed of carbon bar or copper wire. The heating element 40 is electrically connected to the control device 10 so that a patient may feel a degree of comfort when using the auxiliary diagnosis device 20 in massage or rehabilitation. Further, it may function as a hot pack.

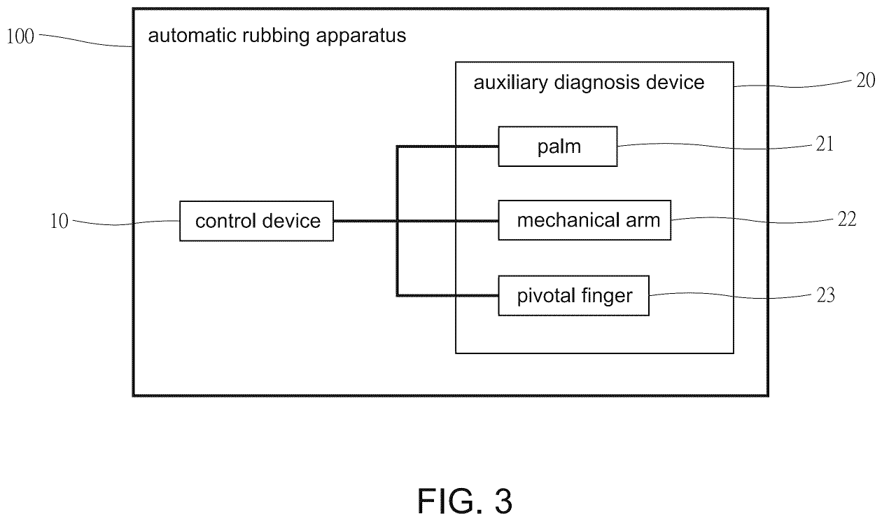

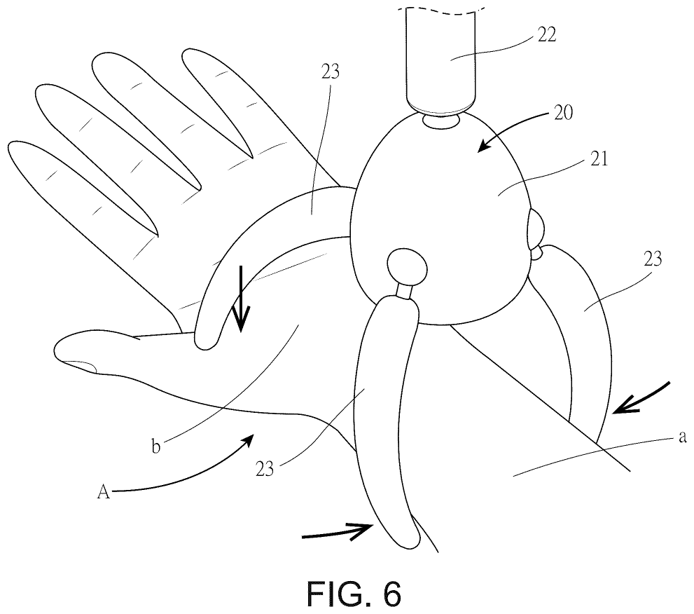

As shown in FIGS. 3 and 6 specifically, an upper limb A of a patient is stabilized by and massaged by the pivotal fingers 23. In the embodiment, the number of the pivotal fingers 23 is three and the body part of the patient to be treated is upper limb A. The auxiliary diagnosis device 20 is electrically connected to the control device 10. In operation, the control device 10 may move the mechanical arm 22 to the upper limb A and activate the two pivotal fingers 23 to stabilize the wrist a and further activate the third pivotal finger 23 to press the palm b. As a result, the purpose of massage or rehabilitation is achieved.

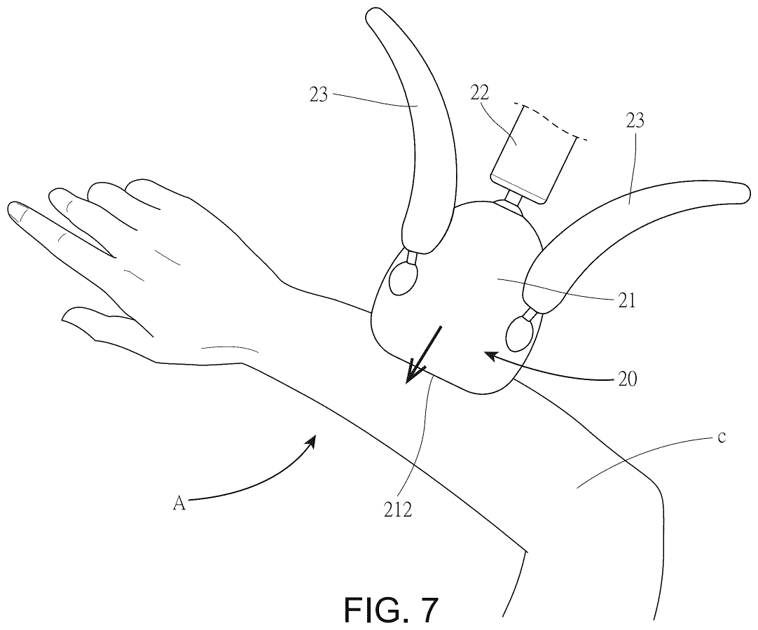

As shown in FIGS. 3 and 7 specifically, the forearm c of the patient massaged or pressed by the palm 212 is illustrated. The control device 10 activates the pivotal fingers 23 to rotate upward, i.e., the ends of the pivotal fingers 23 pointing upward. As a result, the palm 212 will not be interfered by the pivotal fingers 23 during the massaging or pressing operation. As a result, the forearm c may be pressed by the palm 212.

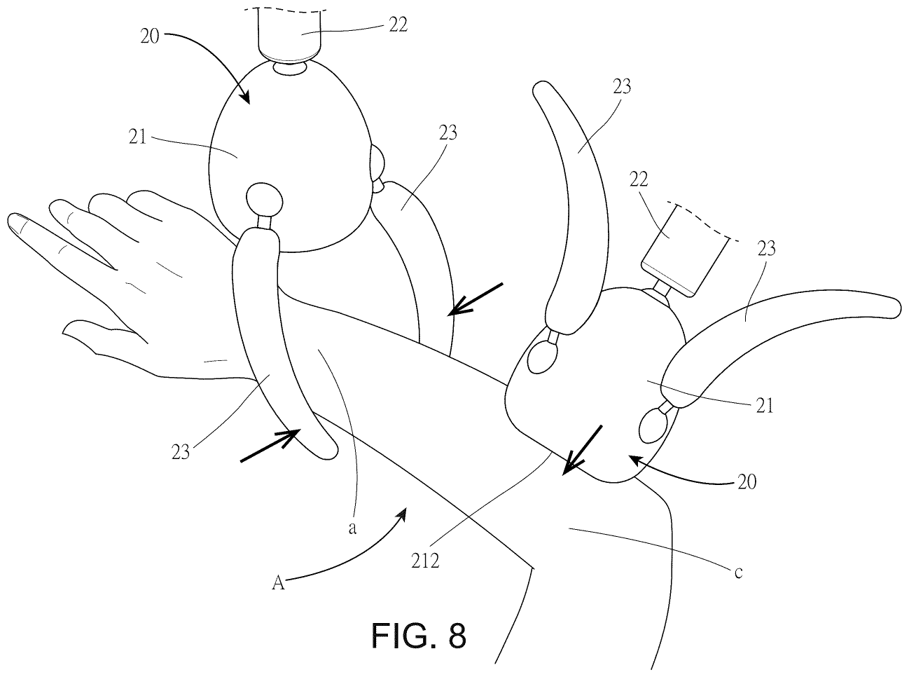

As shown in FIG. 8 specifically, in use of the invention the forearm c is stabilized by and massaged by the two auxiliary diagnosis devices 20 respectively in which the pivotal fingers 23 of one auxiliary diagnosis device 20 are stabilized the wrist a and the palm 212 of the hand 21 of the other auxiliary diagnosis device 20 massages the forearm c. As a result, the rehabilitation efficiency is greatly increased due to the concurrent activation of the two auxiliary diagnosis devices 20.

Alternatively, a physical healing bed (not shown) is used in cooperation with the invention. Still alternatively, the invention is installed beside the physical healing bed. First, the patient may perform a posture as instructed by a physical therapist. Next, the control device 10 activates the hand 21, the mechanical arm 22, and the pivotal fingers 23 to stabilize and press the body part to be treated based on the above identified method. As a result, the body part of the patient is massaged or rehabilitated.

The mechanical arm 22, the pivotal fingers 23, and the hand 21 cooperate to operate as a whole and independently similar to the hand and the fingers of a human being. That is, the body part of the patient is massaged or rehabilitated similar to by means of a human hand. For example, the thumb and the palm press the body part concurrently. As a result, the efficiency of the patient rehabilitated by the physical therapist is greatly increased with the assistance of the invention.

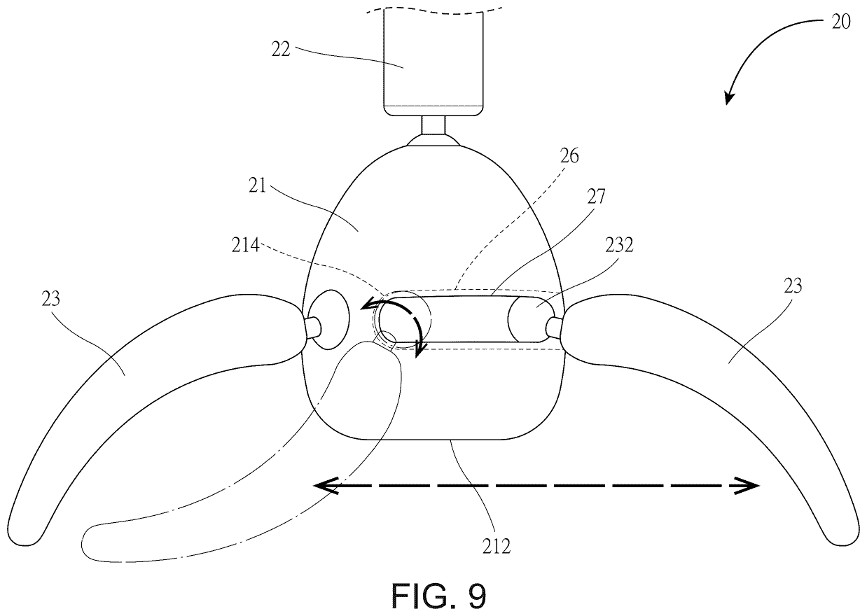

Referring to FIG. 9, an automatic massage apparatus in accordance with a second preferred embodiment of the invention is shown. The characteristics of the second preferred embodiment are substantially the same as that of the first preferred embodiment except the following: at least one transverse channel 26 is provided in an outer surface of the hand 21 and communicates with the second socket 214. A rail 27 is provided in the transverse channel 26. The second universal joint 232 in the second socket 214 is also provided on the rail 27. The control device 10 activates the pivotal finger 23 which in turn move the second universal joint 232 back and forth alternately along the rail 27. As a result, one pivotal finger 23 may approach the other pivotal finger 23 or move away from the other pivotal finger 23. As a result, the pivotal fingers 23 may operate nimbly.

While the invention has been described in terms of preferred embodiments, those skilled in the art will recognize that the invention can be practiced with modifications within the spirit and scope of the appended claims.

What is claimed is:

1. An automatic massage apparatus, comprising:
a control device; and
an auxiliary diagnosis device including a hand, a mechanical arm, and a plurality of pivotal fingers wherein the auxiliary diagnosis device is electronically connected to the control device which controls the hand, the mechanical arm, and the pivotal fingers, the hand includes a dorsal palm as a top surface and a palm as a bottom, the dorsal palm includes a first socket, the mechanical arm includes a first universal joint at an end, the first universal joint is pivotably disposed in the first socket so that the hand is configured to pivot about the mechanical arm at any angle, the hand further comprises a plurality of second sockets on a surface, the pivotal fingers each include a second universal joint at an end, and the second universal joint is pivotably disposed in the second socket so that the pivotal finger is configured to pivot about the hand at any angle.

2. The automatic massage apparatus of claim 1, further comprising at least one transverse channel in an outer surface of the hand, the at least one transverse channel communicating with one of the second sockets, and a rail in the at least one transverse channel wherein the second universal joint in one of the second sockets is disposed on the rail, and the control device is configured to activate the pivotal finger to move the second universal joint back and forth alternately along the rail.

3. The automatic massage apparatus of claim 1, wherein the first universal joint and the first socket are complementary and the second universal joint and the second socket are complementary.

4. The automatic massage apparatus of claim 1, further comprising a elastic layer on an outer surface of each of the palm and the pivotal finger.

5. The automatic massage apparatus of claim 1, further comprising a heating element in each of the palm and the pivotal finger, the heating element being electrically connected to the control device.
